(19) United States
(12) Patent Application Publication
(10) Pub. No.: US 2020/0380368 A1
(43) Pub. Date: Dec. 3, 2020

(54) DATA MODELLING SYSTEM, METHOD AND APPARATUS

(71) Applicant: ALPHANUMERIC LIMITED, Sheffield South Yorkshire (GB)

(72) Inventor: Martin BENSON, Sheffield South Yorkshire (GB)

(21) Appl. No.: 16/769,293

(22) PCT Filed: Dec. 4, 2018
(86) PCT No.: PCT/GB2018/053511

§ 371 Date: Jun. 3, 2020

(30) Foreign Application Priority Data
Dec. 4, 2017 (GB) 1720170.8

(51) Int. Cl. G06N 3/08; G06F 17/16

(52) U.S. Cl. CPC G06N 3/082; G06Q 40/025; G06F 17/16

(57) ABSTRACT

In a method of modelling data, using a neural network, the neural network is trained using data comprising a plurality of input variables and a plurality of output variables, wherein the method comprises constraining the neural network so that a monotonic relationship exists between one or more selected input variables and one or more related output variables.

The present invention relates to a method for data modelling, and is concerned particularly with a method of data modelling using an artificial neural network.

The modelling of data, to provide ever more reliable predictive tools, has become increasingly important in several areas, including (but not limited to) financial, commercial, industrial and scientific processes.

Reliable predictions of a result, based upon selected input conditions, requires the creation of an algorithm that can be used to direct a computer to perform a process. The algorithm effectively embodies a model that is able to calculate an expectation for a particular outcome, given a set of input variables.

If a historical data set is available, this can be used to generate an optimised model by considering the relationship, or correlation, between a set of inputs and the known outputs. Conveniently, so-called machine learning techniques, often involving an iterative approach, can be used to process the data in this manner.

For several decades neural networks (NN) (more properly termed artificial neural networks (ANN), but the terms are used interchangeably here) have been used in the refinement of data models. A neural network is a computing system that comprises a number of layers of connected neurons—or nodes—each of which is able to perform a mathematical function on a data item.

Typically, the network comprises input and output layers, as well as often a number of so-called hidden layers, in which the useful operations are performed.

The functions performed by the various neurons varies and the operation of the neural network as a whole can be tuned in various ways, including by varying numeric weight values that are applied to the functions of individual neurons. Other ways of altering the process include the adding or removal of individual neurons and/or layers. However, deleting neurons, and/or layers, can be detrimental to the sophistication of the model, and can result in the model being unable to express some desired characteristics of the system being modeled. Indeed, in the instance where all but one of the neurons were removed, the model is reduced to a Generalised Linear Model (GLM)—an older, simpler type of model that is strictly less capable (ANNs are known to be universal function approximators, whereas GLMs are not).

One area in which data modelling has become increasingly valuable in recent times is that of the reliable estimation of risk when providing or extending credit to a person or an organization.

The objective in so called “credit scoring” is to produce effective risk indicators that help make better decisions on where it is appropriate to extend credit. Predictive modelling techniques have been applied to this task since at least the 1980s, and have been broadly adopted since the 1980s. Key requirements for a credit model include:
1. It Can be shown to be effective in rank ordering prospective customers in terms of their credit risk
2. Justification can be provided as to why a prospective customer received the score it did, and hence that the dynamics of how the score is determined should be intuitive and defensible. There are at least two reasons for this:
   a. In the case where someone is declined for credit based on a score, they have the right to request an explanation for how their score was arrived at. In the USA, lenders must explicitly produce “adverse reason codes” that indicate which factors were especially detrimental to a score. In the UK lenders must supply general information on reasons for being declined, but need not provide bespoke, detailed reasoning on a customer-by-customer basis. Nevertheless, there is still a strong expectation that the score assigned to a customer should be justifiable, given their characteristics. For example. It may be deemed inappropriate—in any instance—for a neural network to penalise an applicant for having higher than average income.
   b. The cost of accepting a bad credit prospect can be significant and so there is also a strong justification for ensuring that no anomalous decisions are made, to the extent that it is possible. In particular, it would be deemed highly undesirable that a credit prospect be accepted because the scoring model assigned him or her a high score based on a piece of derogatory information.

This requirement is most often addressed by ensuring that certain input variables to the neural network have a monotonic relationship with its output, i.e. that as the input variable increases the output always increases or always decreases.

Requirement (2) has acted to prevent adoption of neural networks (and other nonlinear modelling techniques) within the field of credit scoring, since there was no known method of producing neural networks that behave in this way. Instead, the industry has preferred to use GLMs, for which achieving the desired behaviours is straightforward. This is despite the potential for generating models that are mere powerful (in terms of discriminatory power) by using neural networks.

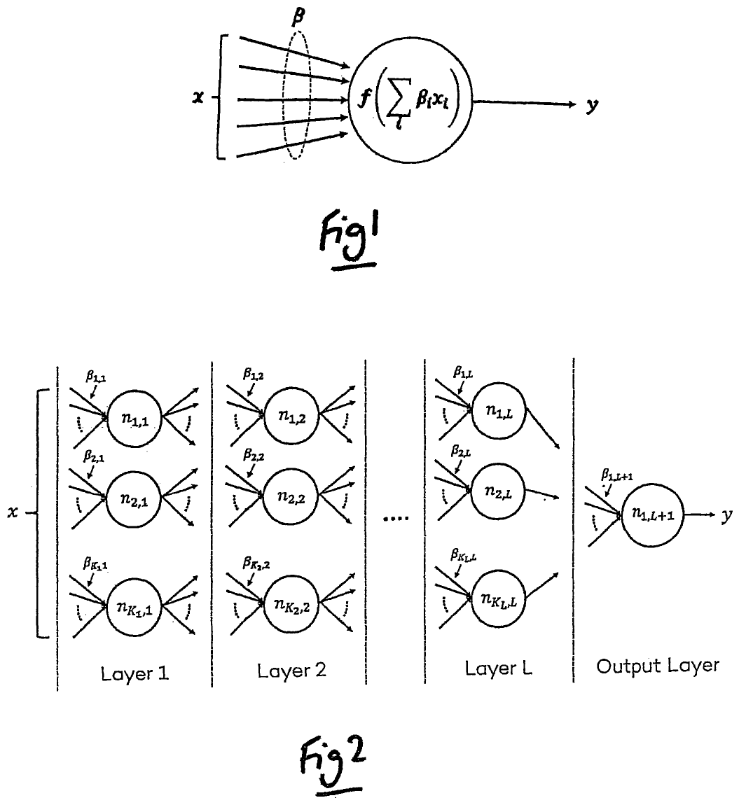

As noted, historically, credit scoring models are linear or logistic regression models (types of GLM), both of which are depicted in FIG. 1, (with

ƒ:x [symbol] x and ƒ:x [symbol] 1/1+e^{-x}

respectively). They receive an input vector X∈ [symbol] ⁿ and produce an output y∈ [symbol] . The models are defined by a parameter vector β, that is optimised during the model training process.

In contrast, with reference to FIG. 2, a common type of neural network model (a fully-connected feed-forward neural network) consists of many such units (“neurons”), arranged in L+1 layers. Each layer can consist of any (positive) number of neurons. Every neuron broadcasts its output to all of the neurons in the next layer (only). Each neuron aggregates its inputs and passes the result through an “activation function” ƒ as depicted in FIG. 1. However, in the case of a neural network the function used is typically not linear or logistic (in contrast to GLMs). Instead, rectified linear unit (relu) activations are commonly used: ƒ:x [symbol] max(0,x). Neural network models are strictly more expressive than linear or logistic models (provided that non-linear activation functions are used) and can, in fact, approximate any continuous function on [symbol] ⁿ to an arbitrary degree of precision (which linear/logistic models cannot).

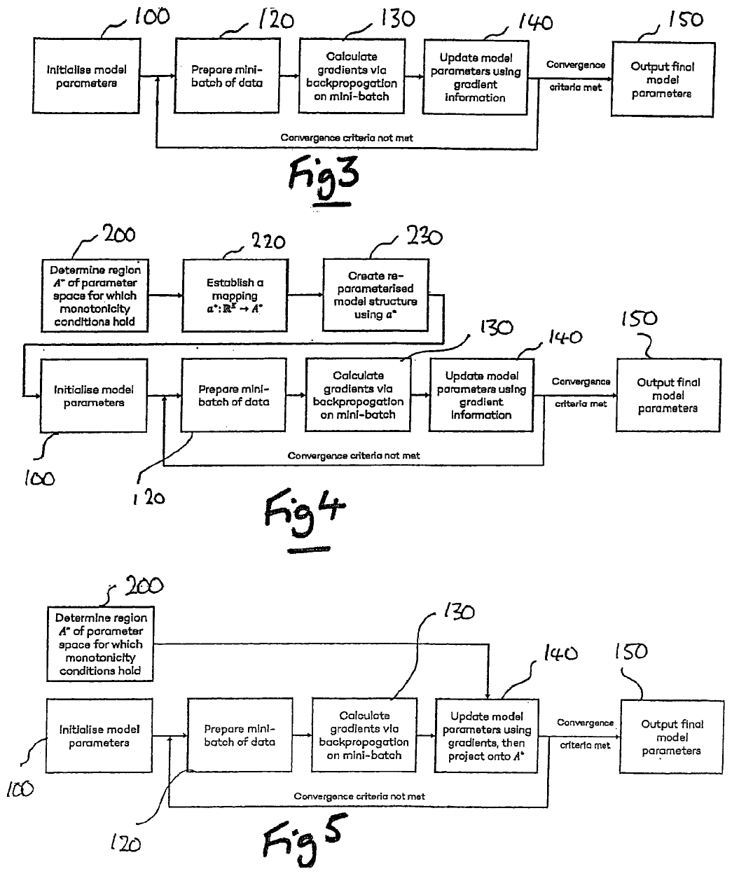

Referring to FIG. 3, neural networks are trained via an iterative process that seeks to minimise a loss function by adjusting the model parameters. First, the model parameters are initialised (Step 100), most often by being set to small random numbers. At each iteration, a mini-batch of data is prepared (Step 120), typically by randomly sampling a small number of records from the input data, and then these records are used to calculate the gradient of the (partial) loss function with respect to the model parameters (Step 130). The gradients are used to make updates to the model parameters (Step 140), which are then tested against some convergence criteria. If those criteria are met, the process terminates, and the final model parameters are output (Step 150). Otherwise a new mini-batch is prepared and the process repeats.

While this approach is effective in determining a model that can accurately predict an outcome, it is very likely that it will incorporate counter-intuitive relationships between some of the input variables and the output being achieved. This will render the model unacceptable within credit, risk contexts, where regulatory concerns require the ability to understand how the model will behave in all circumstances, for the reasons set out above. One approach to solving this problem might be to test whether the desired relationships hold for all records in the data that is available for testing, and in the instance where it does not hold for some variable, that variable is deleted from the model and the model retrained and retested iteratively until no undesirable behavior is evident. There are, however, significant problems with that approach:
The approach does not guarantee that the model will behave as desired when applied to new datasets. Just because undesirable behavior is not observed on the test data, that does not mean that it might not be observed when it is applied to other data.
The method is wasteful in the sense that variables are (needlessly) removed from the model when they nay carry useful predictive information
The method is slow since testing and iterating the model training process in this manner would be extremely time-consuming

Embodiments of the present invention aim to address at least partly the aforementioned problems.

The present invention is defined in the attached independent claims, to which reference should new be made. Further, preferred features may be found in the sub-claims appended thereto.

According to one aspect of the present invention, there is provided a method of modelling data using a neural network, the method comprising training the neural network using data comprising a plurality of input variables and a plurality of output, variables, wherein the method comprises constraining the neural network 30 that a monotonic relationship exists between one or more selected input variables and one or more related output variables.

In a preferred arrangement the neural network has at least one hidden layer comprising a plurality of neurons, each neuron having an ascribed parameter vector, and the method includes modifying the parameter vectors of one or more neurons to ensure that any desired monotonic relationships are guaranteed.

Preferably the method comprises placing a constraint on a range of values that are allowable when deriving values for parameter vector entries during training of the neural network.

Preferably the method comprises employing a re-parameterisation step in the training of the neural network.

In a preferred arrangement, the re-parameterisation step comprises defining a subjective mapping ƒ that maps any given set of parameter vectors into a set of parameter vectors that meet the conditions for any desired monotonic relationships to be guaranteed.

The invention also comprises a program for causing a device to perform a method of modelling data using a neural network, the method comprising training the neural network using data comprising a plurality of input variables and a plurality of output variables, wherein the method comprises constraining the neural network so that a monotonic relationship exists between one or more selected input variables and one or more related output variables.

According to another aspect of the present invention, there is provided an apparatus comprising a processor and a memory having therein computer readable instructions, the processor being arranged to read the instructions to cause the performance of a method of modelling data using a neural network, the method comprising training the neural network using data comprising a plurality co input variables and a plurality of output variables, wherein the method comprises constraining the neural network so that a monotonic relationship exists between one or more selected input variables and one or more related output variables.

The invention also includes a computer implemented method comprising modelling data using a neural network, the method comprising training the neural network using data comprising a plurality of input variables and a plurality of output variables, wherein the method comprises constraining the neural network so that a monotonic relationship exists between one or more selected input variables and one or more related output variables.

In a further aspect, the invention provides a computer program product on a non-transitory computer readable storage medium, comprising computer readable instructions that, when executed by a computer, cause the computer to perform a method of modelling data using a neural network, the method comprising training the neural network using data comprising a plurality of input variables and a plurality of output variables, wherein the method comprises constraining the neural network so that a monotonic relationship exists between one or more selected input variables and one or more related output variables.

According to another aspect of the present invention, there is provided a system for modelling data using a neural network having a plurality of input variables and a plurality of output variables, the system comprising a host processor and a host memory in communication with a user terminal, and wherein the host processor is arranged in use to train the neural, network, using data stored in the memory, by constraining the neural network so that a monotonic relationship exists between one or more selected input variables and one or more related output variables.

Preferably the host processor is arranged in use to present an initial set of variables for selection at the user terminal. The host processor is preferably arranged to configure one or more of the variables in accordance with instructions received from the user terminal.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

FIG. 1 shows schematically a previously considered credit-scoring model;

FIG. 2 is a schematic representation of a generic neural network model;

FIG. 3 shows schematically a training process for a neural network according to the prior art;

FIG. 4 is a schematic representation of a training process for a neural network according to a first embodiment of the present invention;

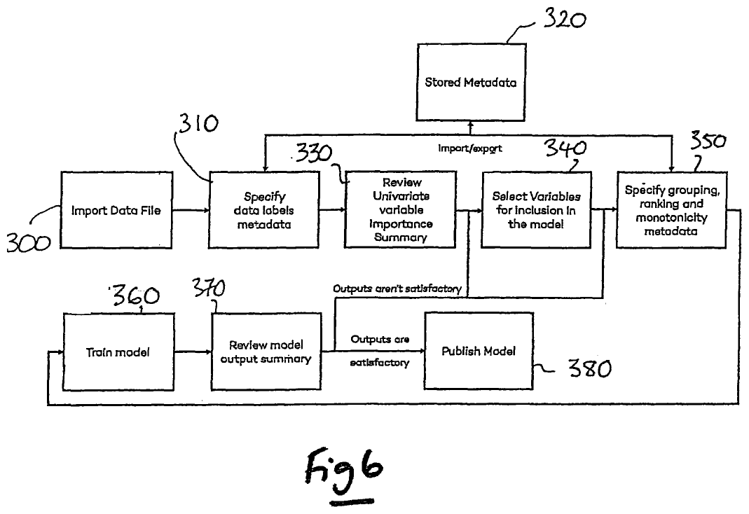

FIG. 5 is a schematic representation of a training process for a neural network according to a second embodiment of the present invention; and

FIG. 6 is a schematic flow process diagram showing a method for developing a predictive data model in accordance with the embodiments of FIGS. 4 and 5.

Neural network models comprise of a number of interconnected neurons (FIG. 2), each of which performs a simple computation based on the inputs that it receives and then broadcasts an output to other neurons. The specifics of what each neuron does is governed by a collection of parameters that describe how to weight the inputs in that calculation. By tuning all of the parameters across the whole network, it is possible to improve the outputs that it generates, making them more closely aligned with intended behavior.

In accordance with the present invention, data modeling techniques have been designed using neural networks that adhere to monotonicity constraints chosen by a user. This can ensure that specified common-sense relationships are obeyed in the model.

This is done by translating the monotonicity constraints into conditions that the parameters of the model must adhere to in order to achieve them. Then the usual model training process is amended in order to ensure that the parameters meet those conditions at all times as model training progresses. This contrasts to the ordinary situation, in which there are no restrictions on the values that the parameters are allowed to take as the model is trained.

Turning to FIG. 4, it is possible to work out the region—which is denoted A*—of the parameter space [symbol] ^{K} (comprising all of the parameter vectors associated with neurons in the network) for which the desired monotonicity relationships are satisfied (Step 200). A surjective, differentiable function α*: [symbol] ^{K} [symbol] A* is constructed (Step 220) that can map any element of [symbol] ^{K} to an element of A*. That function can then be used to form a re-parameterised model (Step 230) by replacing the parameter vector β_{i,j} of each neuron with a re-parameterized version β_{i,j}^{*}:=α*|_{i,j}(β_{i,j}) (where α*|_{i,j} denotes the restriction of α* to the dimensions of [symbol] ^{K} corresponding to the (i,j)th neuron). That is, in the re-parameterised model each neuron computes ƒ(β_{i,j}^{*}) rather than ƒ(β_{i,j}·x), and this ensures that the required monotonicity relationships hold. The training process for the re-parameterised model then proceeds as per FIG. 3.

Turning to FIG. 5, in this alternative approach projected gradient descent is used. This process also ensures that the model parameters lie in the region A* at all stages, meaning that the desired monotonicity relationships are satisfied. Any projection p: [symbol] ^{K}→A* could be used in this process, but the function α* described in FIG. 4 would be the most natural choice.

FIG. 6 is a flow diagram illustrating the process according to the embodiments described above.

An example of how a model may be developed using the above technique will now be described.

A software-as-a-service product may be hosted on servers, and may be accessed by users from a browser over a secure internet connection.

Users upload datasets (Step 300) that may be used to generate predictive models. Users can input data labels (Step 310) in order to help them interpret the data values more easily. For instance, they would be able to label the variable “ResStat” as “Residential Status” and label the value “H” as “Homeowner” and “T” as “Tenant”. Data labels can be supplied either by keying them in, or by importing from a file (Step 320).

Within the ‘specify data labels’ process (Step 310), the user also identities to the system some of the essential components of the model, such as the outcome field that is to be predicted. The outcome variable may be either binary or continuous.

The user is presented with statistical summaries (Step 330) to help the user determine which variables in the dataset should be included within the neural network model (Step 340). These summaries rank (i) the bivariate strength of association between each variable and the outcome variable and (ii) the degree of correlation between any pair of variables that have been selected for inclusion in the model. The system also generates a “default” selection of variables to include based on these statistics, based on simple heuristics, though the user is free to override the selection as they wish.

The user can then scrutinize the variables that have been selected for inclusion in the model and configure the following variable specifications (Step 350):

In the case of continuous input variables, the user can:
Indicate whether the variable should have a monotonic relationship with the model's output, and if so, in which direction the relationship should be.
Specify any “special” values of the variable that should be considered to fall outside of the range of the monotonicity requirement. For instance, it might be the case that an age of −9999 should not be forced to be worse than a “real” age value, because it represents missing data.

In the case of categorical variables, to the user can:
Group values of the variable together, where they wish those values to be treated as equivalent by the neural network.
Specify a rank ordering of any subset of the groups such that the output of the network must be monotonic with respect to the ranking.
Any values that are not explicitly assigned to a group are deemed to constitute an “Other” group.

The system creates “default” groupings based on the frequency at which values appear in the data, based on simple heuristics, though the user is free to override these settings.

The user can save the labelling and variable specification information that they have entered. They can subsequently reload those settings should they wish.

Following variable specification, the user can trigger the model training process (Step 360). At the commencement of this stage, a series of derivations are performed in order to render the input data suitable for use as input to the neural network. The training process then runs according to the processes described in this document, ensuring throughout that the resulting model satisfies any monotonicity/ranking conditions that have been specified.

Once the model training process has completed, the user is presented with a variety of charts and statistics (Step 370), providing information on:
The overall discriminatory power of the model.
The alignment of actual and predicted outcomes on a build and validation sample, when split out by any of the variables in the input data (individually).

If they are happy with the model, they can publish it, which is the endpoint of this exercise (step 380). If they wish to make further refinements to the model, they can return to the variable selection process (Step 340) and make adjustments to the data definitions.

A published model can be used to:
Review details of the model, including its output charts and statistics.
Generate predictions on a new dataset.
Generate model code in a number of supported programming languages.

Key to the process is the training algorithm, which is able to produce neural networks that adhere to any monotonicity constraints that have been supplied. There follows an explanation of the algorithm.

Considerable information exists in the public domain concerning how to train neural networks effectively, and there are numerous existing tools that facilitate this. The present example uses an open source software called Tensorflow to generate its neural networks. Other methods may be used without departing from the scope of the present invention.

In accordance with the present embodiment:

Networks are created with a configurable architecture. The user can request how many layers of neurons should be used, and how many neurons there should be in each layer.

Relu activations are used for all hidden layers in order to avoid vanishing gradients, and to allow effective use of deep neural networks. In the case of a binary outcome variable, the output layer uses a sigmoid activation function in order to restrict outputs to the range [0,1]. For continuous outcomes a linear activation is used in the output layer.

Dropout is used to control overfitting. The dropout rate is configurable by the user, but defaults to 0.5.

Batch normalisation is employed to generate robust, fast training progress.

In addition, as mentioned above, in accordance with the present invention monotonic relationships are ensured between certain input variables as specified by the user.

Derivations are performed in order to render the input data suitable for use as input to the neural network. The derivations are such that categorical variable rankings reduce to ensuring monotonic relationships for the derived, numeric input features. Therefore, ensuring monotonicity for continuous variables, and adhering to rankings for categorical ones, are equivalent from the perspective of the neural network training algorithm.

The way that the algorithm ensures monotonic relationships (where they are required to exist), is as follows:
1. It is possible to prove that the following equation holds, which shows how to calculate the gradient of the activations in a layer of the network (including the output layer) with respect, to activations in an earlier layer (including the input layer):

$$\frac{\partial {z}^{l + p}}{\partial {z}^{l}} {\prod }_{i = l + n - 1}^{l} {{I}_{σ ( {\hat{z}}^{i + 1} )} ( {A}^{i} )}^{T}$$

Where
   l is a layer index, and n is some offset to another layer index
   z^{k} denotes the activation vector of the kth layer
   \hat{z}^{k} denotes the vector of outputs of the kth layer, prior to activation
   lₓ for a vector x denotes the matrix consisting only of leading diagonal entries, populated from x in the obvious manner
   A^{k} denotes the weight matrix for the kth layer of the network
2. It is possible to prove that the following property of matrices holds

$${[ {\prod }_{i = 1}^{n} {A}^{l} {I}_{{x}_{l}} ]}_{i , j} \geq 0 ∀ {x}_{l} \geq 0 ⇔ {\prod }_{l = 1}^{n} {[ {A}^{l} ]}_{{k}_{l} , {k}_{l + 1}} \geq 0 ∀ {k}_{2} , … , {k}_{r} ∈ N , {k}_{1} = i , {k}_{n + 1} = j$$

Where:
   [M]_{i,j} denotes the (i,j)th entry of a matrix M.
   For a vector x, x≥0 is used to denote that all of its elements are non-negative
   k₂, . . . , kₙ are valid indices given the matrices A¹, . . . , Aⁿ
3. Because the activation functions used (and the batch normalisation transformation) are non-decreasing functions on [symbol] , points (1) and (2) can be combined to show that the gradient of the output with respect to input i is universally non-negative provided that the following condition on the weight matrices holds:

$${\prod }_{l = 1}^{n} {[ {A}^{l} ]}_{{k}_{l} , {k}_{i + 1}} \geq 0 ∀ {k}_{2} , … , {k}_{n} ∈ ℕ , {k}_{1} = i , {k}_{n + 1} = 1$$

This amounts to a constraint on the range of values that are allowable when deriving values for the parameter vector (weight matrix) entries during the training process. The region in the parameter space thus described is denoted by A* in FIGS. 4 and 5.
4. One method for ensuring that the equation in (3) is satisfied (for those inputs that are required to satisfy it), is to add a re-parameterisation step to the model training process, as depicted in FIG. 4. This amounts to defining a surjective mapping ƒ that maps any given set of matrices into a set of matrices that meet the conditions in (3). The mapping is differentiable and so allows optimisation of the weight matrices via the usual process of gradient descent. Alternatively, projected gradient descent could be used instead, as depicted in FIG. 5.

The network is therefore trained in such a way that at ail stages in generating its solution the monotonicity requirements are met, without wasting variables that may carry useful predictive information. This is achieved by mapping from all parameters to just ones that behave according to the chosen relationships, or for which the desired/selected monotonic relationships are guaranteed.

In accordance with the present invention, neural network models can be constrained so that their outputs can be made to be monotonic in any chosen subset of their inputs. Although the examples described above are concerned with the development of a credit-scoring model, it will be understood by those skilled in the art that systems and methods in accordance with the present invention will find utility in other fields. For example:
Price Elasticity Modelling—This is the problem of modelling the response to price (i.e. how likely is someone to buy at each of a range of conceivable prices) for different customer types. Generally speaking, it is expected that with all other things being equal, as the price of a product increases, demand for it should decrease (this is known as the Law of Demand in microeconomics, though there are possible exceptions to it such as Giffen Goods and Veblen Goods). This is an important monotonicity constraint on how price should appear in a model of price elasticity.
Criminal recidivism—Models are produced to predict the likelihood that criminals will re-offend upon release. Clearly there is a need to understand and control how explanatory factors contribute to such a model if it is to be used as the basis for decision making (e.g. it might be considered undesirable if a recent incidence of violent crime within a prison happened to generate an extremely low probability for someone, by some quirk of the model).
Medical/Pharmaceutical—There are applications of predictive modelling there whore it is important to have guarantees that the model behaves in a particular manner.
Embodiments of the invention are capable of generating monotonic neural networks for any desired feedforward architecture. Also, the method is capable of generating monotonic neural networks for any desired combination of activation functions, provided that they are all non-decreasing

whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A method of modelling data using a neural network, the method comprising training the neural network using data comprising a plurality of input variables and a plurality of output variables, wherein the method comprises constraining the neural network so that a monotonic relationship exists between one or more selected input variables and one or more related output variables.

2. A method according to claim 1, wherein the neural network has at least one hidden layer comprising a plurality of neurons, each neuron having an ascribed parameter vector, and the method includes modifying the parameter vectors of one or more neurons to ensure that any desired monotinic relationships are guaranteed.

3. A method according to claim 1, wherein the method comprises placing a constraint on a range of values that are allow able when deriving values for parameter vector entries during training of the neural network.

4. A method according to claim 1, wherein the method comprises employing a re-parameterisation step in the training of the neural network.

5. A method according to claim 4, wherein the re-parameterisation step comprises defining a surjective mapping ƒ that maps any given set of parameter vectors into a set of parameter vectors that meet the conditions for any desired monotonic relationships to be guaranteed.

6. A program for causing a device to perform a method of modelling data using a neural network, the method comprising training the neural network using data comprising a plurality of input variables and a plurality of output variables, wherein the method comprises constraining the neural network so that a monotonic relationship exists between one or more selected input variables and one or more related output variables.

7. An apparatus comprising a processor and a memory having therein computer readable instructions, the processor being arranged to read the instructions to model data using a neural network, wherein the processor is arranged to train the neural network using data comprising a plurality of input variables and a plurality of output variables, and to constrain the neural network so that a monotonic relationship exists between one or more selected input variables and one or more related output variables.

8. A computer implemented method comprising modelling data using a neural network, the method comprising training the neural network using data comprising a plurality of input variables and a plurality of output variables, wherein the method comprises constraining the neural network so that a monotonic relationship exists between one or more selected input variables and one or more related output variables.

9. A computer program product on a non-transitory computer readable storage medium, comprising computer readable instructions that, when executed by a computer, cause the computer to perform a method of modelling data using a neural network, the method comprising training the neural network using data comprising a plurality of input variables and a plurality of output variables, wherein the method comprises constraining the neural network so that a monotonic relationship exists between one or more selected input variables and one or more related output variables.

10. A system for modelling data using a neural network having a plurality of input variables and a plurality of output variables, the system comprising a host processor and a host memory in communication with a user terminal, and w herein the host processor is arranged in use to train the neural network, using data stored in the memory, by constraining the neural network so that a monotonic relationship exists between one or more selected input variables and one or more related output variables.

11. A system according to claim 10, wherein the host processor is arranged in use to present an initial set of variables for selection at the user terminal. The host processor is preferably arranged to configure one or more of the variables in accordance with instructions received from the user terminal.

12. A system according to claim 10, wherein the neural network has at least one hidden layer comprising a plurality of neurons, each neuron having an ascribed parameter vector, and the system is arranged in use to modify the parameter vectors of one or more neurons to ensure that any desired monotonic relationships are guaranteed.

13. A system according to claim 10, wherein the system is arranged in use to place a constraint on a range of values that are allowable when deriving values for parameter vector entries during training of the neural network.

14. A system according to claim 10, wherein the system is arranged in use to perform a re-parameterisation in the training of the neural network.

15. A system according to claim 14, wherein the re-parameterisation comprises defining a surjective mapping ƒ that maps any given set of parameter vectors into a set of parameter vectors that meet the conditions for any desired monotonic relationships to be guaranteed.
